(19) United States
(12) Patent Application Publication
(10) Pub. No.: US 2007/0240592 A1
(43) Pub. Date: Oct. 18, 2007

(54) Inkjet printing system for an offset

(75) Inventors: Wolfgang Ronecker, Ehingen (DE); Peter Schulmeister, Pfaffenhofen (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG, Offenbach am Main (DE)

(21) Appl. No.: 11/732,666

(22) Filed: Apr. 4, 2007

(30) Foreign Application Priority Data
Apr. 4, 2006 (DE) 10 2006 016 065.7

(51) Int. Cl. B41F 7/02

(52) U.S. Cl. 101/217

(57) ABSTRACT

To make it possible for a printing press that operates by the offset printing principle to add additional information, including variable information and information that repeatedly changes during a printing run, to any desired place within the printed product, an add-on unit in the form of an inkjet printing system is provided. The unit includes an inkjet printhead mounted on a crosshead is positioned transversely to the direction of web transport in an operating position relative to a web of paper within the printing press in a printing unit or at least in the vicinity of a printing unit.

### BACKGROUND OF THE INVENTION

1. Field of the Invention

The invention concerns an add-on unit in the form of an inkjet printing system for a printing press that operates by the offset printing principle.

2. Description of the Related Art

In printing presses that operate by the offset printing principle, especially in web-fed rotary presses, inkjet printing units are finding increasing use, especially for individualizing printed products produced by offset printing, such as address printing, bar codes, numbering, and other types of labeling. Inkjet printing systems of this type have at least one inkjet printhead, which can be designed according to the continuous inkjet principle, the drop-on-demand inkjet principle, the thermal inkjet principle, the bubble inkjet principle, or any other inkjet principle. The inkjet printheads usually have a bank of jets that consists of several jets arranged side by side, by which printing inks can be directed onto a substrate to be printed, such as a web of paper.

Inkjet printing systems of this type are generally used in the post-processing sections of printing production lines, since the inkjet printing speed is usually much slower there than the processing speed in the rotary press printing operation. However, this has the disadvantage that the use of the additional printing remains limited to a small area on the outside of the printed product.

Inkjet technology is widely used in the state of the art for both home/office applications and industrial applications (digital proof systems, which directly use the database of EDP/digital printers).

For industrial printing applications, inkjet printing systems are already available. Inkjet systems are used for producing proofs, for setting images on printing plates or printing forms, or explicitly for the digital printing of small special production runs (e.g., printing structural shapes) and special formats (e.g., large-format posters or textiles). Much like the situation with home/office inkjet printing applications, where industrial applications are concerned, inkjet printing systems are used mainly for very small printing runs, and the costs for printing inks are very high. Compared to conventional printing methods, such as offset printing itself, inkjet printing is not economical for the production run, because inkjet printing is very slow at high printing resolutions.

US 2005/0193911 discloses an inkjet printing system that is used as a coating unit in such a way that a separate inkjet printer in the form of an array or bank of inkjet printheads is used for the line-by-line application of ink to the preferably large-format substrates, such that the substrate passes below the outlets of the inkjet printheads.

### SUMMARY OF THE INVENTION

An object of the present invention then is to make it possible for a printing press that operates by the offset printing principle to add additional information, including variable information and information that repeatedly changes during a printing run, to any desired place within the printed product.

With the add-on unit of the invention for a printing press that operates by the offset printing principle, especially a web-fed offset newspaper printing press, in the form of an inkjet printing system, at least one inkjet printhead mounted on a crosshead is positioned transversely to the direction of printing in an operating position relative to a web of paper within the printing press, preferably in a printing unit or at least in the vicinity of a printing unit.

It is also possible to use the add-on unit of the invention upstream of the given printing unit in the printing press.

Inkjet printing is a printing technology that belongs to the category of nonimpact printing, which is a printing method in which there is no contact and a tiny amount of ink is shot onto the substrate from one or more extremely small jets under electronic control (as is described, for example, in DE 27 04 514 C2). The advantage of noncontact printing methods is that, if necessary, upstream drying operations can be eliminated, so that costs for energy and material can be reduced.

Furthermore, as has already been mentioned, the inkjet printing method can be digitally controlled by what is known as printing image data. This would allow variable design of the printed image.

Compared to the state of the art, the proposal of the invention has the advantage that an inkjet system is already directly integrated in the offset printing press and can be mounted in or moved to different places on different paper webs of the printing presses. This is precisely what makes it possible to add additional information, including variable information and information that repeatedly changes during a printing run, to any desired place within the printed product.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a web-fed offset newspaper printing press with several printing towers comprising 4/4 printing with two stacked 9-cylinder satellites with vertical web running and with add-on units of the invention installed near the upper printing units of the printing towers in a highly schematic side view; and

FIG. 2 shows the installation of FIG. 1 in a highly schematic top view.

### DETAILED DESCRIPTION OF THE PRESENTLY PREFERRED EMBODIMENTS

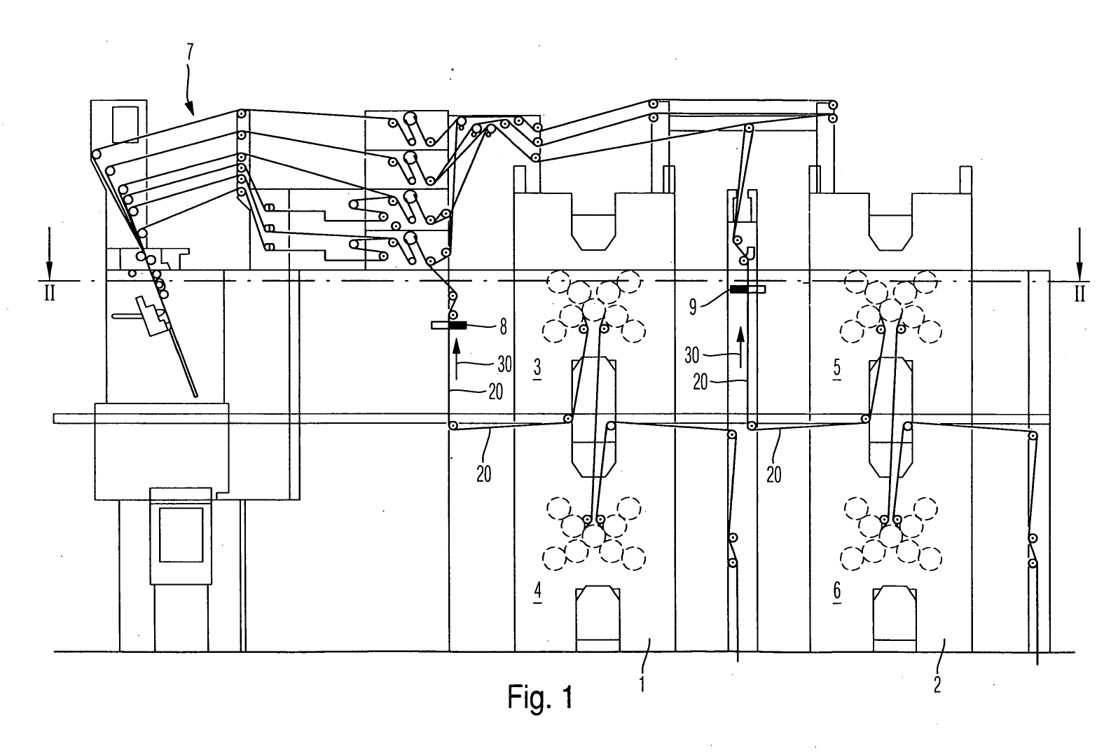

FIG. 1 shows the web lead together with color application in a web-fed offset newspaper printing press, which comprises several printing towers (1, 2) for 4/4 printing with two stacked 9-cylinder satellites (3, 4, 5, 6) with vertical web running per printing tower (1, 2) and a folding unit (7).

An add-on unit in the form of an inkjet printing system (8, 9) is provided for each printing unit tower (1, 2).

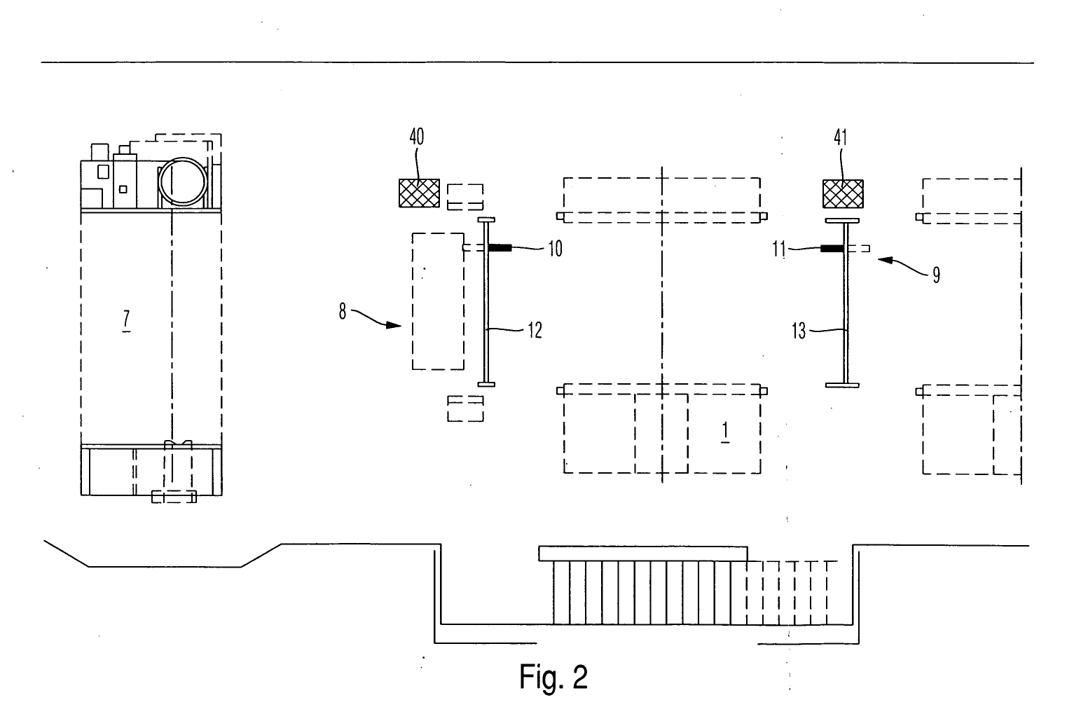

According to FIG. 2, each inkjet printing system (8, 9) comprises an inkjet printhead (10, 11), which is mounted on a crosshead (12, 13) and is positioned transversely to the direction of printing in an operating position relative to a web of paper (20) within the printing unit tower (1, 2).

The inkjet printhead (10, 11) is adjustably mounted on the crosshead (12, 13) in such a way that its position can be adjusted, usually by a control signal but, of course, if necessary, manually as well.

The crosshead (12, 13) can be positioned at any desired place in the printing press, preferably in the printing unit tower opposite the paper web (20) and preferably in a place in which the paper web (20) is flat.

For the sake of simplicity of the drawings, the paper web (20) is shown rather sketchily in FIG. 1 and is not shown at all in FIG. 2.

The paper web (20) is conveyed past the inkjet printheads (10, 11) in a transport direction indicated by the arrows (30).

In accordance with technology that is already well known, each inkjet printhead (10, 11) has a bank of nozzles arranged side by side, through which prinking ink can be directed at a paper web (20) to be printed, which is guided on a cylinder or on a curved guide element, such as a paper guide roller.

Each printhead (10, 11) is preferably arranged in the vicinity of a flat (i.e., vertical) course of the paper web (20) within a printing unit tower (1, 2).

In an alternative embodiment, the inkjet printhead (10, 11) can be positioned in its operating position on a curved surface of a printing unit cylinder, such as a deflecting roller or an impression cylinder.

However, if the printheads (10, 11) are positioned in the vicinity of a flat course of the paper web (20), additional paper guide rollers can be installed to stabilize the paper web (20).

Furthermore, each inkjet printhead (10, 11) is provided with a drive unit (40, 41) or control unit, which is mounted in the printing press installation (i.e., e.g., printing unit side wall) in the immediate vicinity of the associated printhead (10, 11).

The inkjet drive units (40, 41) are thus located in the printing press installation in the vicinity of the printhead, preferably after a web guide plate. The entire inkjet unit, i.e., crosshead (12, 13), printhead (10, 11), and drive unit (40, 41), and the necessary controller hardware have a modular and portable design, so that, if necessary, the positions of the inkjet printing systems within the printing press can be quickly changed.

Each inkjet drive unit (40, 41) can receive a speed signal (encoder signal) and a start signal (zero pulse) from the printing press control system for better synchronization of the location of the impression into the gap provided for this purpose in the copy and the true-to-size imaging of the impression.

Each inkjet unit (8, 9) (or in each case several) can be integrated in such a way that it can be separately operated as an independent unit, and the data can be fed asynchronously to the rest of the data workflow of the printing press during the printing operation. However, each inkjet unit (8, 9) can also be integrated in the control system of the printing press itself (central control console) and can obtain the printing data via the control system of the printing press. In this case, a completely continuous workflow can be realized from the printing preparation to the printing operation.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An inkjet printing system for an offset printing press wherein a web having a width is fed in a transport direction, said system comprising:
a crosshead mounted transversely to the transport direction; and
an inkjet printhead movably mounted on the crosshead so that the printhead can be fixed at any desired operating position relative to the width of the web.

2. The system of claim 1 wherein the crosshead is mounted adjacent to a flat course of the web.

3. The system of claim 2 further comprising paper guide rollers which stabilize the web adjacent to the crosshead.

4. The system of claim 1 wherein the crosshead is mounted adjacent to a curved course of the web, where the web runs over a roller.

5. The system of claim 1 further comprising a drive unit for the printhead, wherein the drive unit is mounted on the press immediately adjacent to the printhead.

6. The system of claim 5 wherein the system has a modular design, so that the system can be positioned at multiple locations in the printing press.

7. The system of claim 5 wherein the drive unit receives a start signal and a speed signal from a printing press control system, wherein the signals synchronize the timing and the size of an impression printed by the inkjet printhead with the location of a gap in offset printed copy.

8. The system of claim 7 wherein the drive unit can be operated by the printing press control system so that image data to be printed by the inkjet printhead is fed asynchronously to the data workflow for offset printing.

9. The system of claim 7 wherein the drive unit is integrated in the printing press control system so that image data to be printed by the inkjet printhead is fed synchronously to the data workflow for offset printing.
